(19) United States
(12) Patent Application Publication
(10) Pub. No.: US 2006/0193251 A1
(43) Pub. Date: Aug. 31, 2006

(54) Online reservation processing system and method

(75) Inventor: Sharon Huang, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/121,105

(22) Filed: May 4, 2005

(30) Foreign Application Priority Data
Feb. 25, 2005 (TW) 094105880

(51) Int. Cl. H04J 1/16

(52) U.S. Cl. 370/222

(57) ABSTRACT

An online reservation processing system comprises a receiving module and a translating module. The receiving module receives a reservation application datum, which comprises an initial time and a final time. In addition, the translating module separates a period from the initial time to the final time into a plurality of sub-periods, and separates the reservation application datum into a plurality of reservation application sub-data according to the sub-periods. The time-length of each sub-period equals a default time-length. An online reservation processing method applied with the online reservation processing system is also provided.

### BACKGROUND OF THE INVENTION

1. Field of Invention

The invention relates to a reservation processing system and a reservation processing method, and more particularly to an online reservation processing system and an online reservation processing method.

2. Related Art

The reservation management of the public resource is very complicated. If the public resource is managed in a manual manner on papers according to a time-sharing manner, it is difficult to provide the query, register and reservation for the public, and the user tends to unintentionally register the error reservation time. The method of manually adjusting the reservation time tends to cause errors. So, the errors may be reduced if the electric reservation system may be used to replace the method of manual management on papers.

Thus, it is an important subject of the invention to provide an online reservation processing system and an online reservation processing method so as to manage the reservation register and enable the user to conveniently register or query the reservation time.

### SUMMARY OF THE INVENTION

In view of the foregoing, the invention is to provide an online reservation processing system and an online reservation processing method.

To achieve the above, an online reservation processing system of the invention includes a receiving module and a translating module. The receiving module receives a reservation application datum, which includes an initial time and a final time. The translating module separates a period from the initial time to the final time into a plurality of sub-periods, and separates the reservation application datum into a plurality of reservation application sub-data according to the sub-periods, wherein a time-length of each of the sub-periods equals a default time-length.

In addition, the invention also provides an online reservation processing method, which includes the steps of: receiving a reservation application datum, which includes an initial time and a final time; and separating a period from the initial time to the final time into a plurality of sub-periods, and separating the reservation application datum into a plurality of reservation application sub-data according to the sub-periods, wherein a time length of each of the sub-periods equals a default time-length.

As mentioned hereinabove, because the online reservation processing system of the invention has the translating module, the whole reservation format of the reservation application data can be processed, and the reservation application data can be properly translated from the whole reservation format into the time interval format so that the user can conveniently register or query the reservation time.

### BRIEF DESCRIPTION OF THE DRAWINGS

The invention will become more fully understood from the detailed description given herein below illustration only, and thus is not limitative of the present invention, and wherein:

FIG. 1 is a block diagram showing an online reservation processing system according to a preferred embodiment of the invention;

FIG. 2 is a block diagram showing the online reservation processing system, which includes a database, according to the preferred embodiment of the invention;

FIGS. 3A and 3B are schematic illustrations showing the online reservation processing system according to the preferred embodiment of the invention, wherein the outputting module outputs sub-periods on an user interface of a monitor; and

FIG. 4 is a flow chart showing an online reservation processing method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

The online reservation processing system according to the preferred embodiment of the invention will be described with reference to the accompanying drawings.

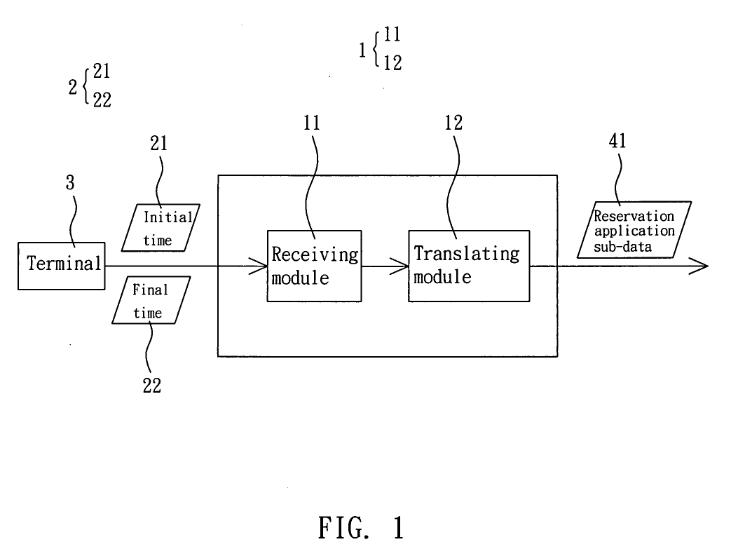

Referring to FIG. 1, an online reservation processing system 1 according to a preferred embodiment of the invention includes a receiving module 11 and a translating module 12. The receiving module 11 receives a reservation application datum 2 transferred by a terminal 3, and the reservation application datum 2 includes an initial time 21 and a final time 22. In addition, the translating module 12 separates a period from the initial time 21 to the final time 22 into a plurality of sub-periods, and separates the reservation application datum 2 into a plurality of reservation application sub-data 41 according to the sub-periods. The time-length of each of the sub-periods equals a default time-length. The application times represented by the reservation application sub-data do not overlap with one another.

For example, the initial time 21 and the final time 22 of the reservation application datum 2 are AM 9:00 and AM 10:30 on Jan. 1, respectively. If the default time-length is set as 30 minutes, the reservation application datum 2 may be divided into three time intervals, which are not overlapped and have three sub-data with the same time-length. The initial to final times of the three sub-data are from AM 9:00 to AM 9:30 on Jan. 1, from AM 9:30 to AM 10:00 on Jan. 1, and from AM 10:00 to AM 10:30 on Jan. 1, respectively.

In addition, the reservation application datum may further include a periodic entry, which represents the reservation period (e.g., every week, every month, or everyday) of the reservation application datum. Consequently, it is unnecessary to divide the reservation application datum into a plurality of sub-data on different dates at the beginning of the application, and only the periodic rule of the reservation application datum has to be stored. When the user wants to make a query, the periodic reservation application datum may be translated into a plurality of sub-data on different dates. Thus, the data storage space may be greatly reduced, and it is also possible to conveniently provide the function of querying the reservation datum for the user.

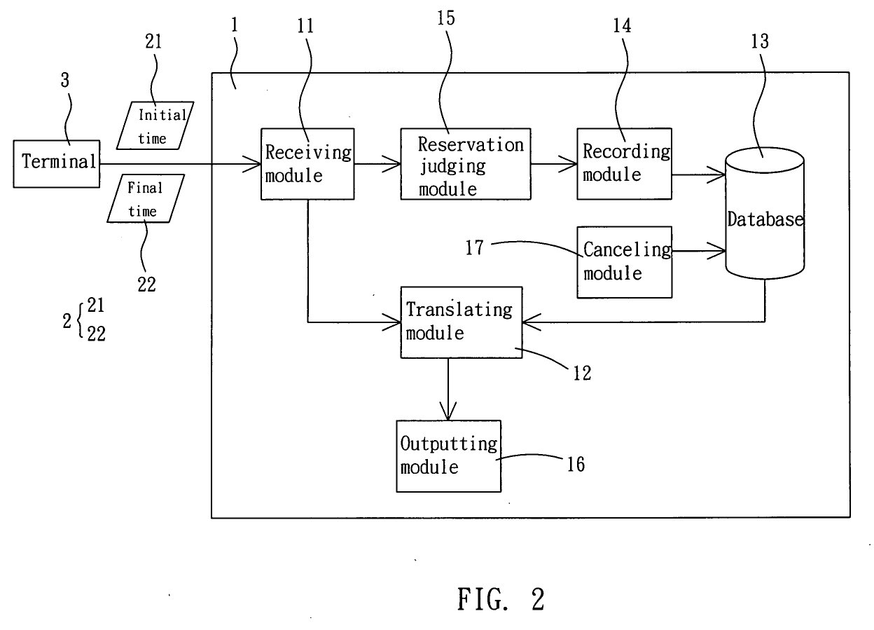

As shown in FIG. 2, the online reservation processing system 1 according to the preferred embodiment of the invention further includes a database 13, a recording module 14, a reservation judging module 15, an outputting module 16 and a canceling module 17. The database 13 stores a plurality of reservation records, each of which includes an initial time record and a final time record. The recording module 14 adds a reservation record, which includes the reservation application datum, to the database 13. The reservation judging module 15 judges whether or not the reservation application datum overlaps with each of the reservation records. When the reservation application datum does not overlap with each of the reservation records, the recording module 14 adds a reservation record to the database 13. The added reservation record includes the reservation application datum. The outputting module 16 outputs the reservation application datum and at least one of the reservation records. The canceling module 17 selects one of the reservation records from the database according to the reservation application datum, and marks one reservation-canceling flag in the reservation record.

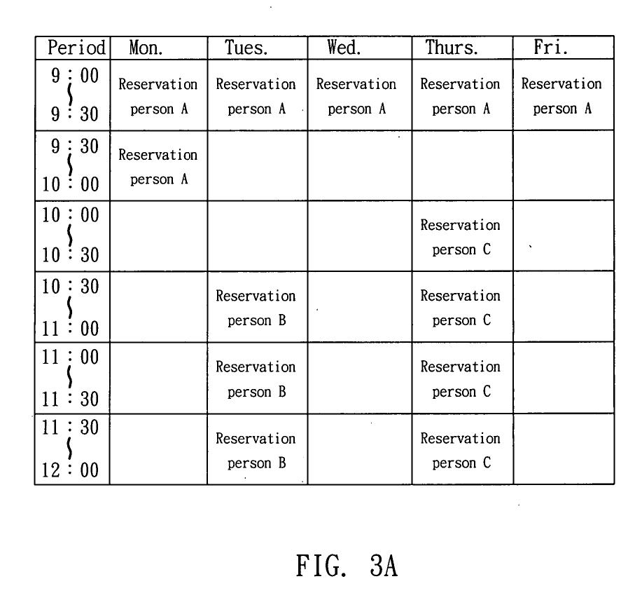

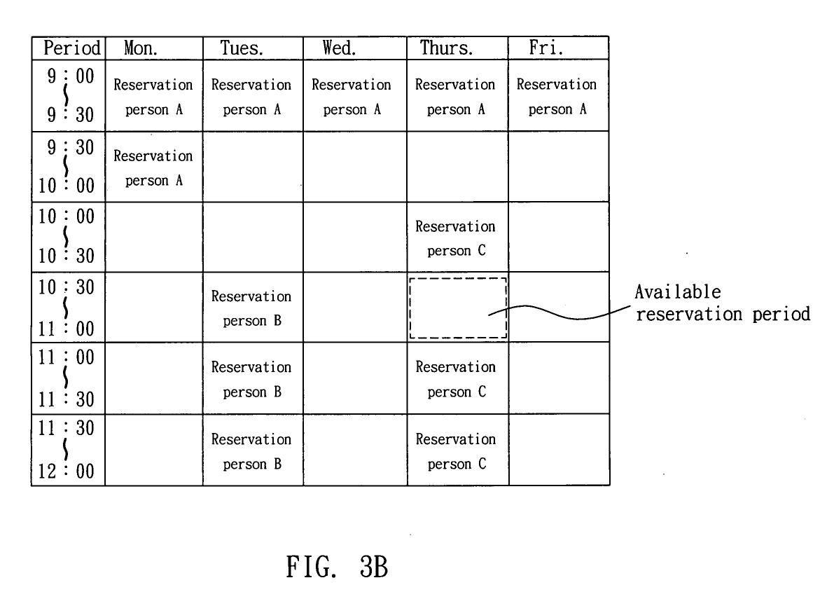

As shown in FIG. 3A, the translating module 12 can separate a period from the initial time to the final time of the reservation application datum and the reservation record into a plurality of sub-periods, each of which includes the reservation application datum and the datum of the reservation person in the reservation record. The outputting module 16 can output the sub-periods to the user interface of the monitor so as to facilitate the user to query or amend the datum.

In addition, as shown in FIG. 3B, if the reservation person C cancels the reservation from 10:30 to 11:00 on Thursday, the time interval may be free for the reservation of other users. Consequently, each time interval may be reserved by the user in a more flexible manner. Correspondingly, the user can register the reservation time or cancel the reservation time more conveniently.

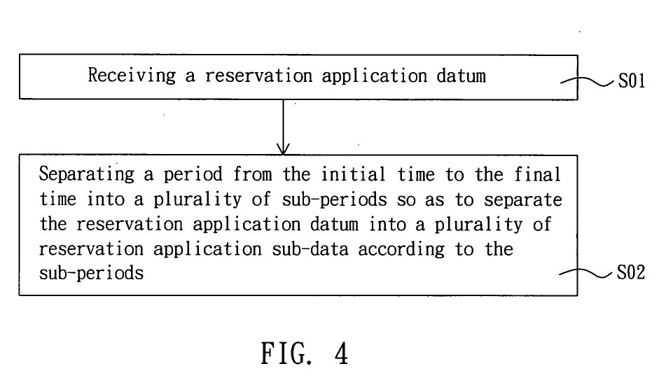

Referring to FIG. 4, an online reservation processing method according to the preferred embodiment of the invention includes steps S01 and S02.

In step S0l, a reservation application datum, which includes an initial time and a final time, is received.

In step S02, a period from the initial time to the final time is separated into a plurality of sub-periods, and the reservation application datum is separated into a plurality of reservation application sub-data according to the sub-periods, wherein a time-length of each sub-period equals a default time-length.

Because the online reservation processing method of this embodiment may be applied to the online reservation processing system shown in FIGS. 1, 2, 3, 4A and 4B, detailed descriptions thereof will be omitted.

In summary, because the online reservation processing system of the invention has the translating module, the whole reservation format of the reservation application data can be processed, and the reservation application data can be properly translated from the whole reservation format into the time interval format so that the user can conveniently register or query the reservation time.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An online reservation processing system, comprising:
a receiving module for receiving a reservation application datum, which comprises an initial time and a final time; and
a translating module for separating a period from the initial time to the final time into a plurality of sub-periods, and separating the reservation application datum into a plurality of reservation application sub-data according to the sub-periods, wherein a time-length of each of the sub-periods equals a default time-length.

2. The online reservation processing system according to claim 1, wherein application times represented by the reservation application sub-data do not overlap with one another.

3. The online reservation processing system according to claim 1, further comprising:
a database for storing a plurality of reservation records each comprising an initial time record and a final time record.

4. The online reservation processing system according to claim 3, further comprising:
a recording module for adding a reservation record to the database, wherein the added reservation record comprises the reservation application datum.

5. The online reservation processing system according to claim 4, further comprising:
a reservation judging module for judging whether or not the reservation application datum overlaps with each of the reservation records, wherein when the reservation application datum does not overlap with each of the reservation records, the recording module adds a reservation record to the database, and the added reservation record comprises the reservation application datum.

6. The online reservation processing system according to claim 3, further comprising:
an outputting module for outputting the reservation application datum and at least one of the reservation records.

7. The online reservation processing system according to claim 3, further comprising:
a canceling module for selecting one of the reservation records from the database and marking a reservation-canceling flag in the reservation record according to the reservation application datum.

8. An online reservation processing method, comprising the steps of:
receiving a reservation application datum, which comprises an initial time and a final time; and
separating a period from the initial time to the final time into a plurality of sub-periods, and separating the reservation application datum into a plurality of reservation application sub-data according to the sub-periods, wherein a time length of each of the sub-periods equals a default time-length.

9. The method according to claim 8, wherein application times represented by the reservation application sub-data do not overlap with one another.

10. The method according to claim 8, further comprising the step of:
storing a plurality of reservation records into a database, wherein each of the reservation records comprises an initial time record and a final time record.

11. The method according to claim 10, further comprising the step of:
adding a reservation record, which comprises the reservation application datum, to the database.

12. The method according to claim 11, further comprising the step of:
judging whether or not the reservation application datum overlaps with each of the reservation records; and
adding a reservation record to the database when the reservation application datum does not overlap with each of the reservation records, wherein the added reservation record comprises the reservation application datum.

13. The method according to claim 10, further comprising the step of:
outputting the reservation application datum and at least one of the reservation records.

14. The method according to claim 10, further comprising the step of:
selecting one of the reservation records from the database according to the reservation application datum and marking a reservation-canceling flag in the reservation record.
